(19) United States
(12) Patent Application Publication
(10) Pub. No.: US 2002/0027418 A1
(43) Pub. Date: Mar. 7, 2002

(54) Plasma display panel structure with a high open ratio

(76) Inventors: Jih-Fon Huang, Jubei City (TW); Yu-Ting Chien, Yunghe City (TW)

Correspondence Address: RABIN & CHAMPAGNE, PC, 1101 14TH STREET, NW, SUITE 500, WASHINGTON, DC, 20005, US

(21) Appl. No.: 09/809,317

(22) Filed: Mar. 16, 2001

(30) Foreign Application Priority Data
Sep. 6, 2000 (TW) 89118277

(51) Int. Cl. H01J 17/49; G09G 3/28

(52) U.S. Cl. 313/584; 313/583; 345/60

(57) ABSTRACT

A plasma display panel has a high open ratio. In the plasma display panel, the ribs are perpendicular to the address electrodes. In addition, a plurality of gaps or indentations are disposed on the transparent electrodes for reducing the influence of crosstalk. Further, by changing the number of address electrodes in the plasma display panel, the driving method can be simplified and the cost of the plasma display panel can be reduced. According to the invention, the plasma display panel can achieve a high open ratio, resulting in an improvement of the brightness.

### BACKGROUND OF THE INVENTION

This application incorporates by reference Taiwanese application Ser. No. 89118277, filed on Sep. 6, 2000.

1. Field of the Invention

The invention relates to a plasma display panel structure with a high open ratio, and more particularly to a color alternating-current plasma display panel (AC PDP) structure with high open ratio.

2. Description of the Related Art

AC PDPs have the following advantages: large in size, wide view, high resolution, and full color display capability. Since the demand for high quality video is ever increasing, one of the major topics of developing plasma display planes is to improve the display quality with high brightness.

Referring to FIG. 1, it illustrates a perspective view of the structure of a conventional AC PDP. In FIG. 1, the front plate 102 has a plurality of pairs of sustaining electrodes X and Y formed in parallel to each another. There is only one pair of sustaining electrodes X and Y shown in FIG. 1. The sustaining electrode X includes a transparent electrode 104 and a bus electrode 106, and the sustaining electrode Y includes a transparent electrode 108 and a bus electrode 110. The bus electrodes 106 and 110 are used for increasing the conductivity of the sustaining electrodes X and Y The transparent electrodes 104 and 108 can be made of transparent material such as indium tin oxide (ITO), and the bus electrodes 106 and 110 can be made of metal such as copper (Cu) or chromium (Cr).

In addition, the sustaining electrodes X and Y are covered by a dielectric layer 112, and the dielectric layer 112 is covered with a protective layer 114. A plurality of address electrodes are formed on a rear plate 116 which is faced to the front plate 102. The address electrodes are covered with a fluorescent layer. As shown in FIG. 1, these address electrodes includes address electrodes A(1), A(2), and A(3). The address electrode A(1) is covered with a red fluorescent layer R, the address electrode A(2) is covered with a green fluorescent layer G, and the address electrode A(3) is covered with a blue fluorescent layer B. The address electrodes A(1), A(2), and A(3) are perpendicular to the sustaining electrodes X and Y. In addition, three sub-pixels are defined by the address electrodes A(1), A(2), A(3), and the sustaining electrodes X and Y, respectively. A pixel is then defined by combining three sub-pixels which respectively emit three different colors.

Along either side of each sub-pixel, rib 118 is formed on the rear plate 116, perpendicular to the sustaining electrodes X and Y Further, the space between the protective layer 114 and the fluorescent layer is defined as discharging gas space 120, and the discharging gas space 120 is filled with discharging gas.

For increasing the resolution and brightness of the PDP, a technique designated as ALIS (alternate lighting of surfaces), was disclosed by Y. Kanazawa, T. Ueda, S. Kuroki, K. Kariya, T. Hirose, “High-resolution interlaced addressing for plasma display”, SID 99 DIGEST, pp. 154-157, 1999. Referring to FIGS. 2 and 3, FIG. 2 illustrates the sustaining electrodes X and Y of the conventional PDP while FIG. 3 illustrates the sustaining electrodes X and Y of the PDP according to ALIS technique.

In FIG. 2, the region between two sustaining electrodes, such as X(1) and Y(1), is to be employed for discharging, which is indicated by one of the ellipses. On the other hand, no discharge will be occurred in the region between two sustaining electrodes that are not regarded as the pair, such as Y(1) and X(2). In this way, in this conventional approach, the pitch between each pair of the sustaining electrodes is larger to prevent the interference between adjacent pixels.

In the plasma display panel utilizing ALIS technique as shown in FIG. 3, the pitch between adjacent sustaining electrodes is equal. The width of the sustaining electrodes X and Y is greater than that of the sustaining electrodes X and Y in the conventional approach. In addition, each bus electrode is disposed in the middle of the transparent electrode. The remaining parts of the plasma display panel utilizing ALIS technique is as the same as shown in FIG. 1. The key feature of ALIS technique is that discharging not only occurs in the region between the sustaining electrode pair such as X(1) and Y(1), but also occurs in the region between the pairs such as Y(1) and X(2) (the regions defined by the ellipses in FIG. 3). In this way, by using the same number of sustaining electrodes, the plasma display panel with ALIS technique is brighter and has higher resolution. The resolution of the PDP with ALIS technique can be increased by 100% as compared with the resolution of the conventional PDP.

As discussed above, the resolution and brightness of the plasma display panel can be improved by using ALIS technique. However, the open ratio of the plasma display panel is restricted because of the ribs being perpendicular to the bus electrodes. Referring to FIG. 4, it illustrates the relationship between the rib and bus electrodes in the plasma display panel using ALIS technique. In FIG. 4, the transparent electrodes 402, 404, 406, and 408, and the bus electrodes 412, 414, 416, and 418 of the respective sustaining electrodes X(1), Y(1), X(2), and Y(2) are perpendicular to the ribs 420, 422, 424, and 416. In a plasma display panel, the open ratio indicates the ratio of the transparent area to the opaque area, the opaque area is the sum of areas occupied by all ribs and bus electrodes. The more the opaque area is, the less the transparent area is. Thus, the open ratio is reduced as the opaque area is increased. Therefore, one of the main purposes of the invention is to reduce the opaque area so that the open ratio can be increased in a plasma display panel, resulting in better brightness and higher resolution.

### SUMMARY OF THE INVENTION

It is therefore an object of the invention to provide a plasma display panel structure with a high open ratio. According to the invention, a plasma display panel has fluorescent layers and ribs perpendicular to address electrodes. For reducing the influence of the crosstalk phenomenon, the transparent electrodes are formed to be discontinuously. In addition, by increasing the number of the address electrodes, the driving method of the plasma display panel can be simplified, resulting in reducing cost of the driving circuit. According to the invention, the plasma display panel can achieve a high open ratio, for improving the brightness.

According to the present invention, it provides a plasma display panel including a front plate, a rear plate, and a plurality of first sustaining electrodes X, second sustaining electrodes Y, address electrodes, ribs, and fluorescent layers. The rear plate is opposite to the front plate. The first sustaining electrodes X and the second sustaining electrodes Y are formed in parallel on the front plate. Each of the first sustaining electrodes X includes a first transparent electrode and a first bus electrode disposed on the first transparent electrode. Each of the second sustaining electrodes Y includes a second transparent electrode and a second bus electrode disposed on the second transparent electrode. The address electrodes are formed on the rear plate and orthogonal to the first sustaining electrodes X and the second sustaining electrodes Y. The ribs are formed on the rear plate, across and orthogonally to the address electrodes, and a plurality of discharge regions are formed between every two adjacent ribs. The fluorescent layers are then formed on the discharge regions.

### BRIEF DESCRIPTION OF THE DRAWINGS

Other objects, features, and advantages of the invention will become apparent from the following detailed description of the preferred but non-limiting embodiments. The description is made with reference to the accompanying drawings, in which:

FIG. 1 is a perspective view showing the structure of a conventional alternating-current plasma display panel;

FIG. 2 shows the relationships among sustaining electrodes X and Y of the conventional plasma display panel;

FIG. 3 shows the relationships among sustaining electrodes X and Y of a plasma display panel using ALIS technique;

FIG. 4 shows the arrangement of ribs and bus electrodes of the plasma display panel using ALIS technique; FIG. 5 is a perspective view showing the structure of the first embodiment of the plasma display panel according to the invention;

FIG. 6 is a top view showing the first embodiment of the plasma display panel according to the invention;

FIG. 7 is a top view showing the second embodiment of the plasma display panel according to the invention;

FIG. 8A is an example illustrating discharge regions and electrode arrangement of the first or second embodiment according to the invention;

FIGS. 8B and 8C illustrate an example of driving waveforms of the first or second embodiment of the plasma display panel according to the invention;

FIG. 8D is another example illustrating discharge regions and electrode arrangement of the first or second embodiment according to the invention;

FIG. 8E illustrates another example of driving waveforms of the first or second embodiment of the plasma display panel according to the invention;

FIG. 9 is a top view showing the third embodiment of the plasma display panel according to the invention;

FIG. 10 illustrates driving waveforms of the third embodiment of the plasma display panel according to the invention; and

FIG. 11 is a top view showing the fourth embodiment of the plasma display panel according to the invention.

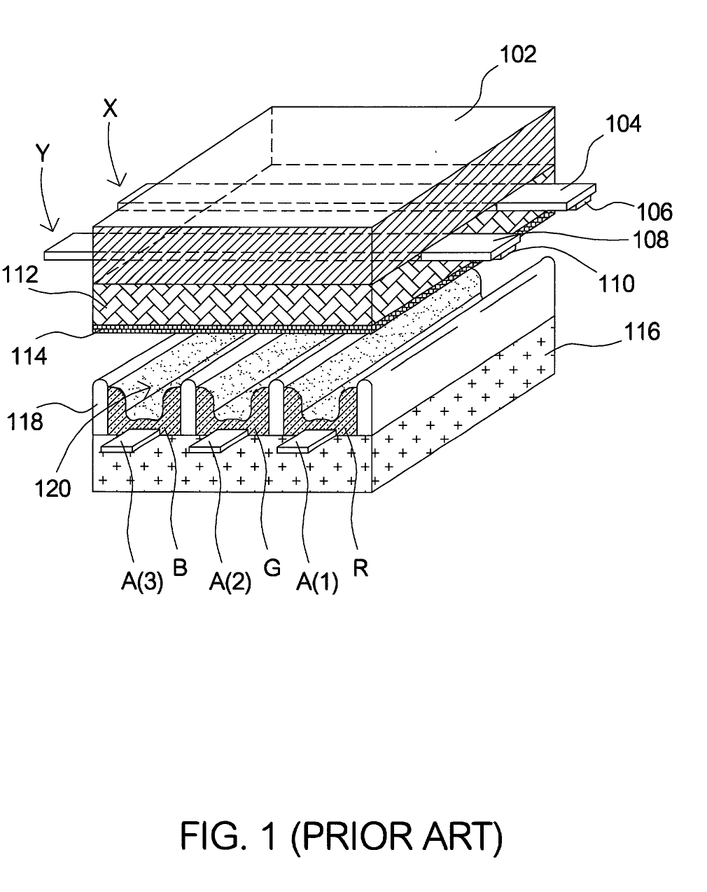

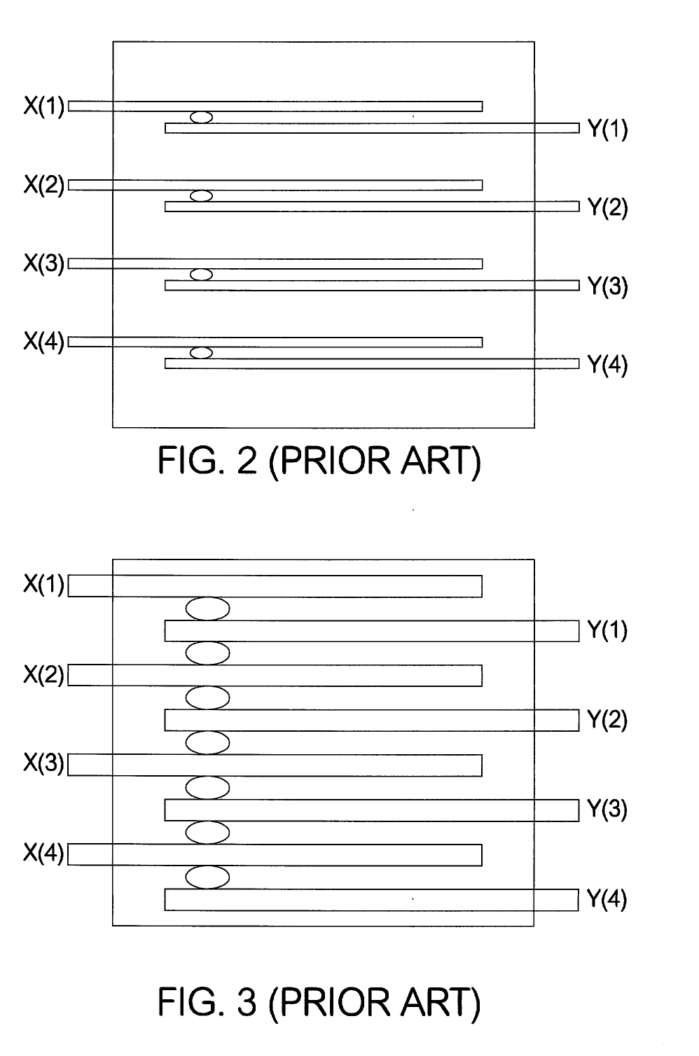

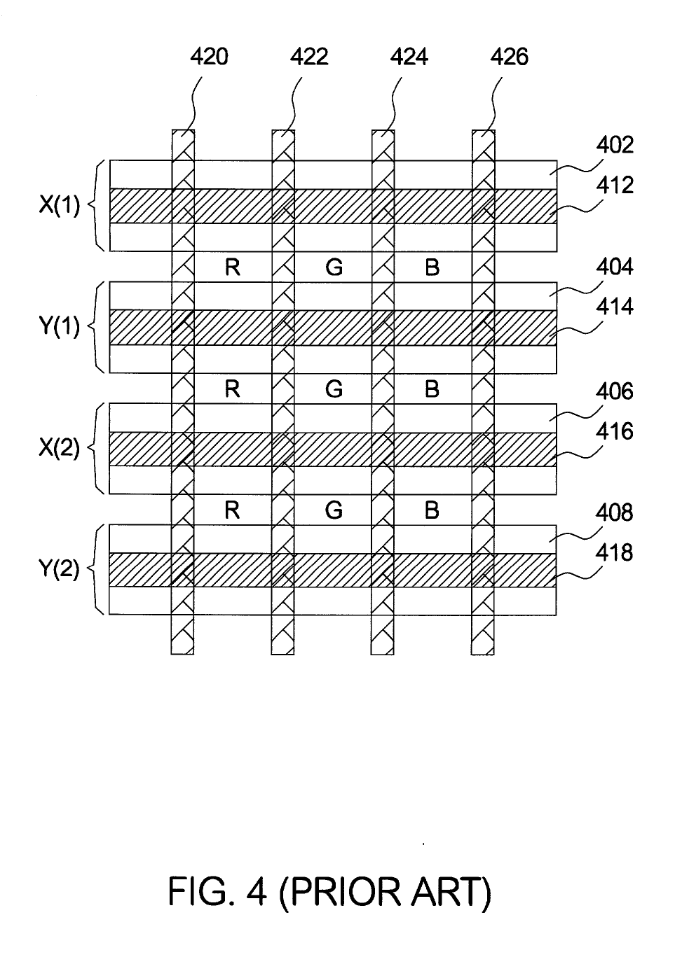

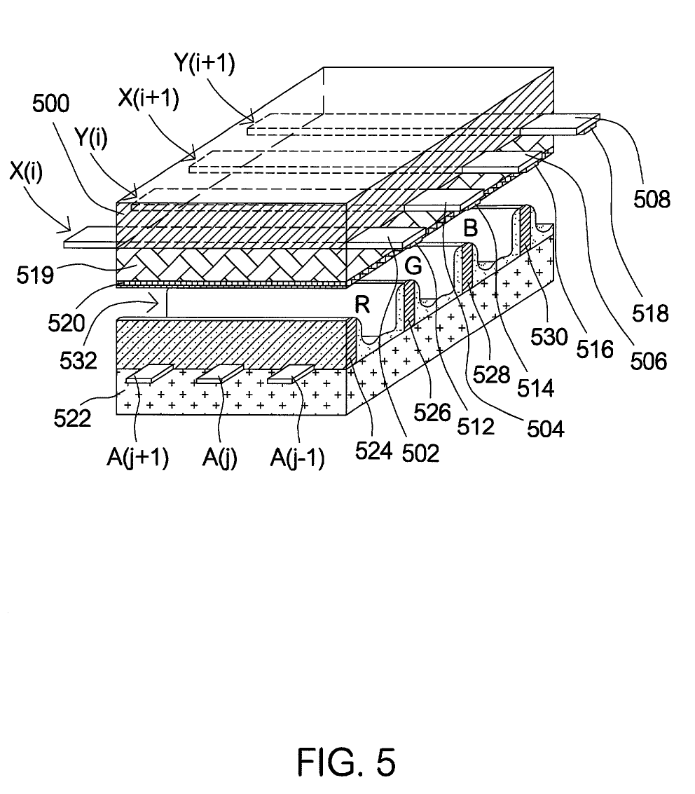

### DETAILED DESCRIPTION OF THE INVENTION

Based on the plasma display panel using ALIS technique as shown in FIG. 3, the invention provides an alternating-current plasma display panel (AC PDP) with an improved open ratio. According to the PDP of the invention, the ribs and fluorescent layers are formed vertically to the address electrodes. In addition, the bus electrodes are formed over the ribs to increase the open ratio and the brightness of the PDP.

Referring to FIG. 5, the PDP includes a front plate 500 and a rear plate 522 parallel and opposite to the front plate, and two pairs of sustaining electrodes X(i), Y(i), X(i+1), and Y(i+1) are taken as an example. A plurality of first and second sustaining electrodes X and Y are alternately formed in parallel on the front plate 500 along a first direction. The second sustaining electrodes Y are paired with and spaced equally apart from the first sustaining electrodes X. Each sustaining electrode includes a transparent electrode and a bus electrode. The bus electrode is disposed along a centerline of the corresponding transparent electrode. In FIG. 5, the transparent electrodes 502, 504, 506, 508 and the bus electrodes 512, 514, 516, 518 constitute these sustaining electrodes X(i), Y(i), X(i+1), and Y(i+1), respectively. Usually, the transparent electrodes are made of transparent material such as indium tin oxide (ITO), and the bus electrodes are made of opaque metals such as Cr/Cu/Cr.

The front plate 500 further includes a dielectric layer 519 disposed on the first and second sustaining electrodes X and Y, and a protective layer 520 formed on the dielectric layer 519. On the rear plate 522, a plurality of address electrodes A are formed along a second direction and parallel to each other. The second direction is vertical to the first direction of the first and second sustaining electrodes X and Y In FIG. 5, the address electrodes A includes A(j−1), A(j), and A(j+1). Ribs 524, 526, 528, and 530 are disposed on the rear plate 522 along the first direction, and partially cover the address electrodes A(j−1), A(j), and A(j+1) respectively. Red fluorescent layer R, green fluorescent layer G, and blue fluorescent layer B are respectively formed between the ribs 524, 526, 528, and 530. These fluorescent layers R, G, B are perpendicular to the address electrodes A. The discharging space 532 is defined between the protective layer 520 and the fluorescent layers, and is filled with discharging gas. In the discharging space 532, a plurality of discharge regions are formed between every two adjacent ribs, where the fluorescent layers are formed on the discharge regions.

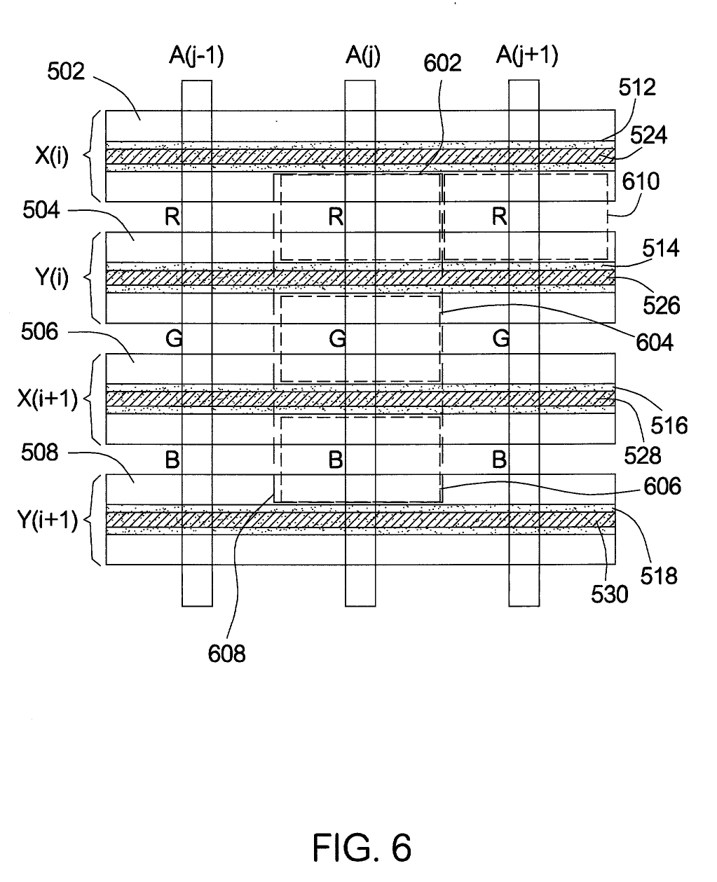

Referring to FIG. 6, it illustrates the ribs and various electrodes in the top view. The bus electrodes 512, 514, 516, and 518 of these sustaining electrodes are made of opaque metal (Cr/Cu/Cr). On the other hand, the ribs 524, 526, 528, and 530 are opaque as well. Therefore, an opaque area defined by these opaque elements. Further, according to the invention, the position of the opaque ribs 524, 526, 528, and 530 on the rear plate 522 are corresponded with the position of the bus electrodes 512, 514, 516, and 518 on the front plate 500. In this way, the opaque area of the plasma display panel is greatly reduced, resulting in a high open ratio over the open ratio of the conventional approach.

In addition, discharge regions are defined by the address electrodes A, the first sustaining electrodes X and the second sustaining electrodes Y For example, a discharge region is defined by the address electrode A(j), the first sustaining electrode X(i), and the second sustaining electrode Y(i). In addition, another discharge region is defined by the address electrode A(j), the first sustaining electrode X(i+1), and the second sustaining electrode Y(i). Each discharge region corresponds to a sub-pixel of a pixel. Three sub-pixels having three fluorescent layers R, G, and B form a pixel, such as the sub-pixels 602, 604, and 606 compose a pixel 608.

However, a crosstalk phenomenon may occur among the sub-pixels in the plasma display panel as shown in FIG. 6. For instance, a large amount of space charges are produced after discharging in the sub-pixel 602, and some of the space charges may enter the sub-pixel 610 to cause undesired discharging in the sub-pixel 610. Therefore, the crosstalk phenomenon may lead to unexpected results.

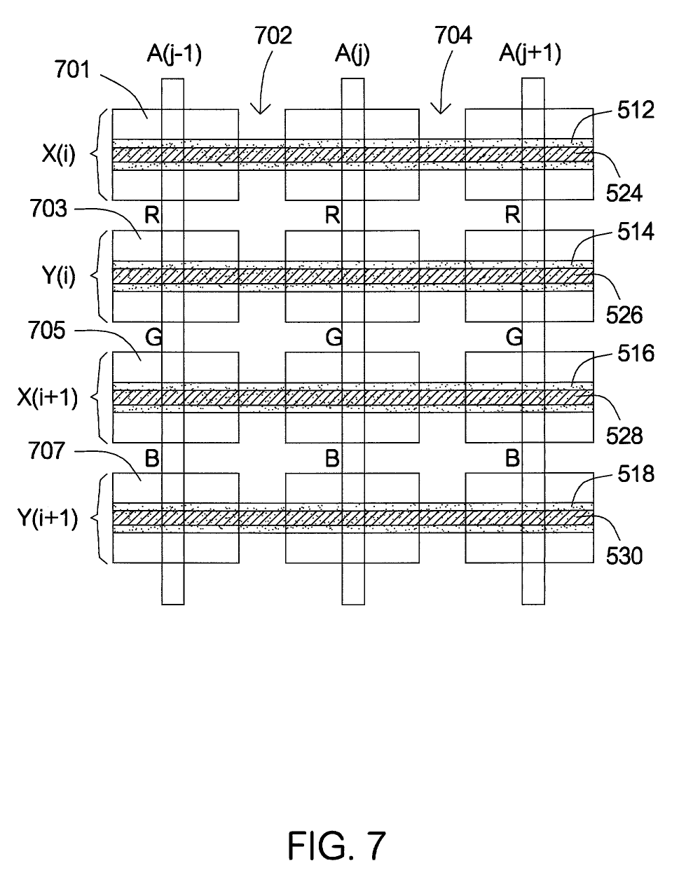

Referring to FIG. 7, it illustrates the second embodiment of the plasma display panel. In FIG. 7, the transparent electrodes are the modifications of the ones shown in FIG. 5 for reducing the crosstalk phenomenon, and the transparent electrodes 701, 703, 705, and 707 correspond to the transparent electrodes 502, 504, 506, and 508 respectively. In order to reduce the crosstalk phenomenon between adjacent sub-pixels, the transparent electrodes are modified according to either approach as follows. Between two adjacent address electrodes, (a) portions of the transparent electrodes are cut off and the corresponding bus electrodes are unchanged, or (b) each transparent electrode has a plurality of indentions to reduce the width of the transparent electrodes at the position between two adjacent address electrodes. Therefore, by using approach (a), the transparent electrodes are cut off to form several gaps, such as the gaps 702 and 704, for reducing the crosstalk phenomenon. By using approach (b), the transparent electrodes have indentions (not shown), so that the width of each transparent electrode equals to the width of the corresponding bus electrode between two adjacent address electrodes for reducing the crosstalk phenomenon. Thus, the gaps or indentions are formed on the transparent electrode between every two adjacent address electrodes, and the bus electrode keeps unchanged for connecting the sustaining electrode of different sub-pixels.

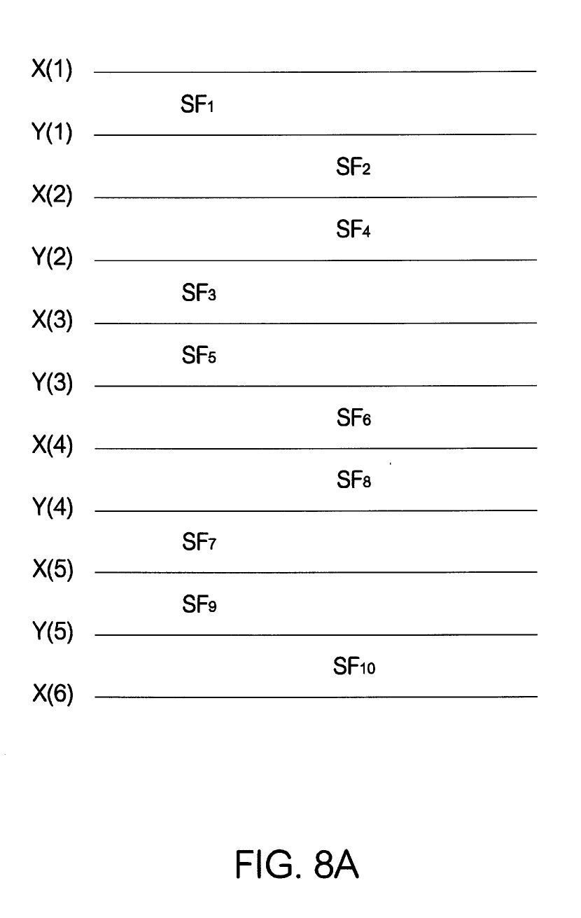

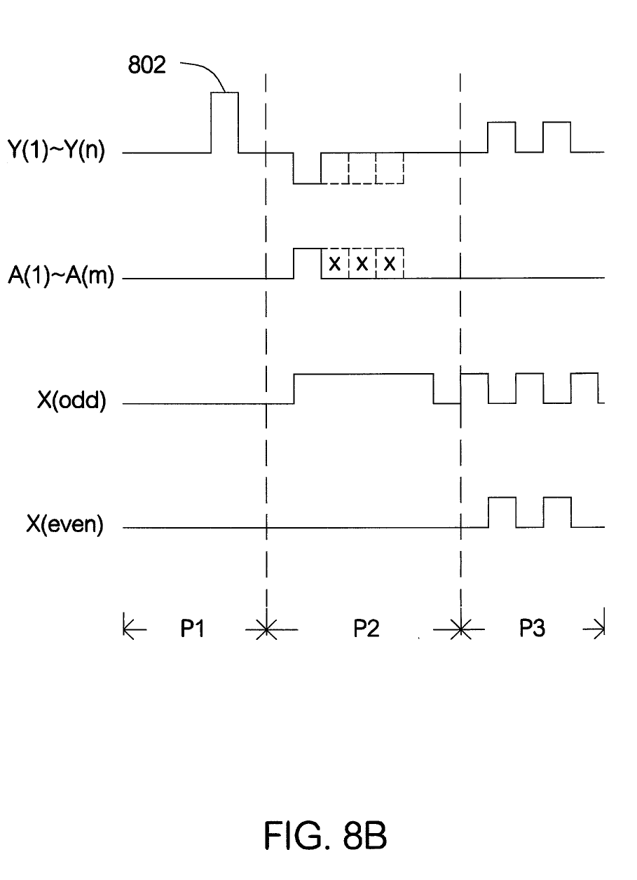

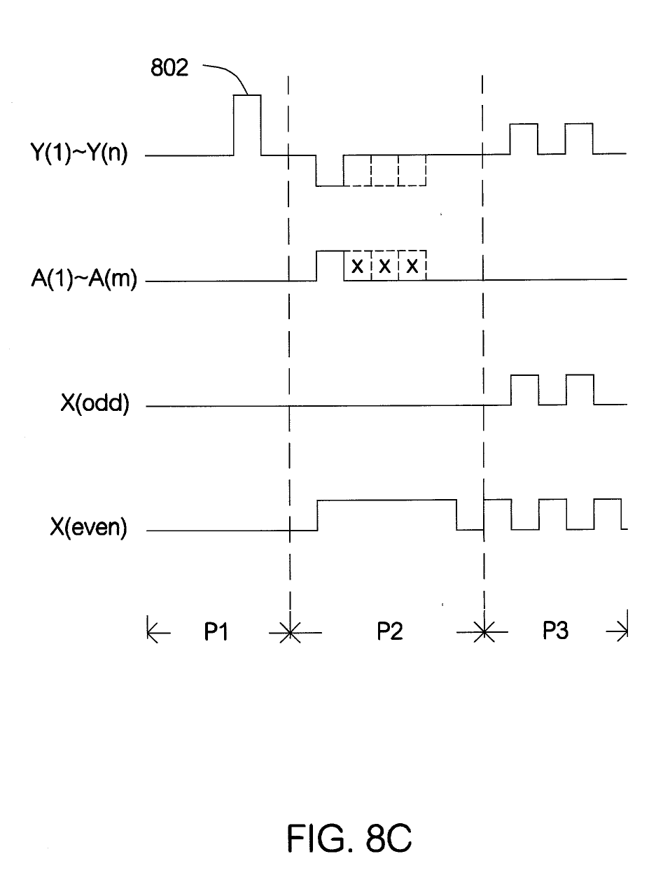

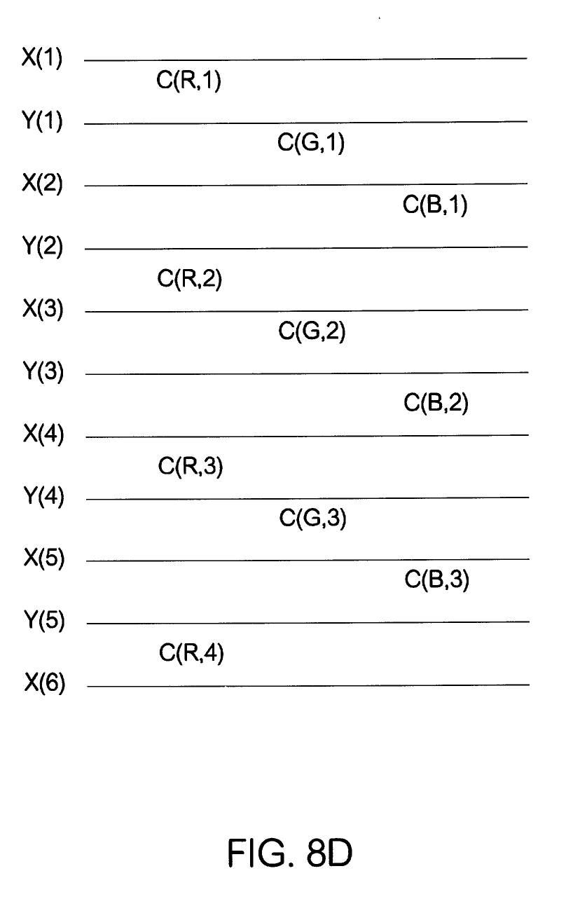

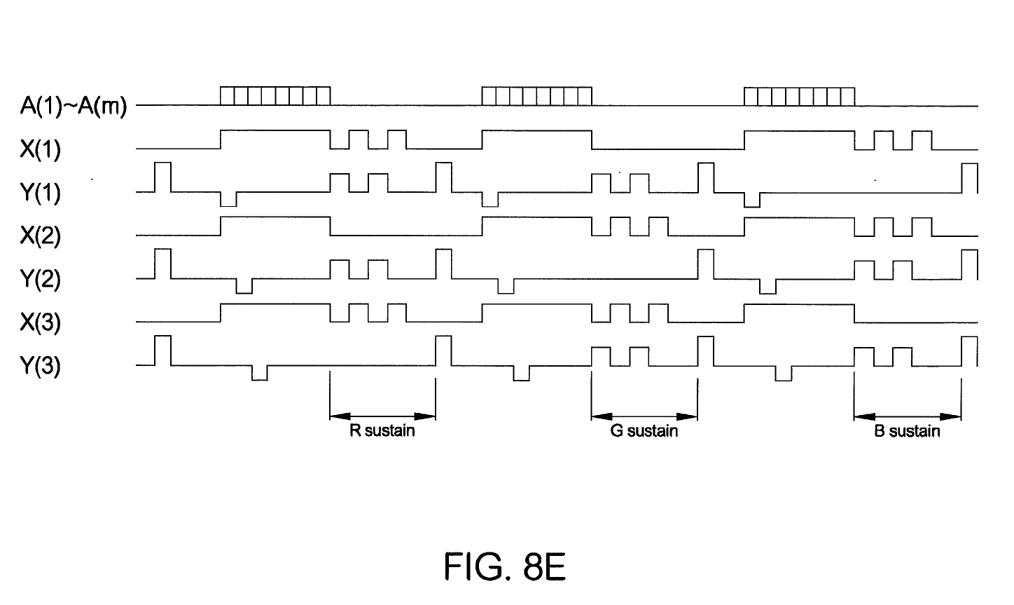

According to the invention, there are two methods for driving the plasma display panel disclosed above. The first driving method has the waveforms of driving signals as shown in FIGS. 8B and 8C, which are similar to ALIS technique. Besides, FIG. 8A is to illustrate the arrangement of the discharged regions by using the electrodes of the first embodiment or the second embodiment.

In FIG. 8A, each second sustaining electrode Y is adjacent to two first sustaining electrodes X, and a discharge region is defined by two adjacent first and second sustaining electrodes X and Y. The first sustaining electrodes X can be divided into odd-numbered sustaining electrodes X(odd) and even-numbered sustaining electrodes X(even). Each second sustaining electrode Y is adjacent to an odd-numbered sustaining electrode X(odd) and an even-numbered sustaining electrode X(even) so as to define an odd-numbered discharge region and an even-numbered discharge region respectively. For instance, the second sustaining electrode Y(1) is adjacent to first sustaining electrodes X(1) and X(2), and the first discharge region SF1 is formed between the first sustaining electrode X(1) and the second sustaining electrode Y(1), and the second discharge region SF2 is formed between the first sustaining electrode X(1) and the second sustaining electrode Y(1). In addition, the discharge regions in FIG. 8A can be grouped into two types: the odd-numbered discharge regions, defined by second sustaining electrodes Y and odd-numbered first sustaining electrodes X(odd), including SF₁, SF₃, SF₅, SF₇, and SF₉, and the even-numbered discharge regions, defined by second sustaining electrodes Y and even-numbered first sustaining electrodes X(even), including SF₂, SF₄, SF₆, SF₈, and SF₁₀.

In the first driving method, each frame of the image data is divided into an odd-numbered sub-frame and an even-numbered sub-frame, and the odd-numbered discharge regions and even-numbered discharge regions are respectively driven by the odd-numbered sub-frame and even-numbered sub-frame. In the address period for each odd-numbered sub-frame, only the odd-numbered sustaining electrodes X(odd) are in a high level voltage; further, only the even-numbered sustaining electrodes X(even) are in the high level voltage during the address period for each even-numbered sub-frame. In this way, the adjacent sub-pixels will not discharge at the same time, and the crosstalk phenomenon between two sub-pixels can be avoided.

Referring to FIGS. 8B and 8C, they illustrate driving signal waveforms for odd-numbered sub-frames and even-numbered sub-frames respectively. For a PDP, driving signal waveforms for each sub-frame includes three periods: a reset period P1, an address period P2, and a sustain period P3. In the embodiment, the first driving method is a plasma display panel including n first sustaining electrodes X(1)-X(n), n second sustaining electrodes Y(1)-Y(n), and m address electrodes A(1)-A(m). The first sustaining electrodes X are further divided into the odd-numbered first sustaining electrodes X(odd) and the even-numbered sustaining electrodes X(even).

During the reset period P1, a reset pulse 802 is applied to all second sustaining electrodes Y(1)-Y(n) simultaneously for removing the wall charges in all discharge regions. If any wall charge remains, discharging will occur in the discharge region. Removing all wall charges can ensure that data can be written correctly to sub-pixels in the following address period P2.

During the address period P2, sequentially inputting a negative pulse to the second sustaining electrodes Y(1)-Y(n), and then selectively inputting a positive pulse to the address electrodes A(1)-A(m) according to the image data of each sub-frame. In other words, discharging occurs in the discharge regions row by row according to the data of each sub-frame, producing wall charges in the selected discharge regions.

As shown in FIG. 8B, for processing the odd-numbered sub-frame, all the odd-numbered sustaining electrodes X(odd) are maintained in the high level voltage during the address period P2, and new wall charges can be produced only in the odd-numbered discharge regions SF₁, SF₃, SF₅, SF₇, and SF₉. For instance, when the odd-numbered first sustaining electrode X(1) maintains in positive voltage, the negative pulse is applied to the second sustaining electrode Y(1), a positive pulse is applied to the address electrode A(1), and the odd-numbered discharge region SF₁ is selected to be discharged. The discharging of the odd-numbered discharge regions is controlled by selecting the address electrodes A(1)-A(m).

In the same way, as shown in FIG. 8C, for processing the even-numbered sub-frame, all the even-numbered sustaining electrodes X(even) are maintained in the high level voltage during the address period P2, and new wall charges can be produced only in the even-numbered discharge regions SF₂, SF₄, SF₆, SF₈, and SF₁₀. For instance, when the even-numbered first sustaining electrode X(2) maintains in positive voltage, the negative pulse is applied to the second sustaining electrode Y(1), a positive pulse is applied to the address electrode A(1), and the even-numbered discharge region SF₂ is selected to be discharged. The discharging of the even-numbered discharge regions is controlled by selecting the address electrodes A(1)-A(m).

During the sustain period P3, because of the memory effect of the wall charges, suitable AC signals are inputted to the second sustaining electrodes Y(1)-Y(n), the first sustaining electrodes X(odd) or X(even) for continuously discharging in the discharge regions selected during the address period P2. Ultraviolet (UV) rays are emitting after discharging, and visible light is produced after the UV rays hit the fluorescent layers.

In the sustain period P3, inputting a first signal to the second sustaining electrodes Y, a second signal to the odd-numbered first sustaining electrodes X(odd), and a third signal to the even-numbered first sustaining electrodes X(even). The first, second, and third signals are all AC signals. The AC signals in the sustain period P3 are different when processing the even-numbered or odd-numbered sub-frames. When processing odd-numbered sub-frames, the odd-numbered discharge regions are selected for discharging, the first signal is out of phase with the second signal, and the first signal is in phase with the third signal. When processing even-numbered sub-frames, the even-numbered discharge regions are selected for discharging, the first signal is in phase with the second signal, and the first signal is out of phase with the third signal.

The second driving method of the plasma display panel is shown in FIG. 8E. Referring to FIG. 8D, it illustrates the discharge regions and the arrangement of the electrodes in the first and second embodiments. In this method, the n first sustaining electrodes X are divided into three groups of first sustaining electrodes X(3k+1), X(3k+2), and X(3k+3), and the n second sustaining electrodes are also divided into three groups of second sustaining electrodes Y(3k+1), Y(3k+2), and Y(3k+3), where n is a positive integer and k is a non-negative integer which is less than n.

In FIG. 8D, the discharge regions are categorized into first, second, and third discharge regions. The first discharge region is discharge region C(R, p) for emitting red light, the second discharge region is discharge region C(G, p) for emitting green light, and the third discharge region is discharge region C(B, p) for emitting blue light, where p is an integer. The discharge region C(R, p) can be defined by the first sustaining electrodes X(3k+1) and the second sustaining electrode Y(3k+1), or by the second sustaining electrode Y(3k+2) and the first sustaining electrode X(3k+3). Similarly, the discharge region C(G, p) can be defined by the second sustaining electrode Y(3k+1) and the first sustaining electrode X(3k+2), or by the first sustaining electrode X(3k+3) and the second sustaining electrode Y(3k+3). The discharge region C(B, p) can be defined by the first sustaining electrode X(3k+2) and the second sustaining electrode Y(3k+2), or by the second sustaining electrode Y(3k+3) and the first sustaining electrode X(3k+4), or X(3k′+1), where 3k′+1 is equal to 3k+4 and is not greater than n.

In the second driving method, the image of every frame is divided into three types, namely, R sub-frame, G sub-frame, and B sub-frame. The R, B, and G sub-frames are then utilized to drive the discharge regions R, G, and B alternately.

Referring to FIG. 8E, it illustrates the waveforms of the driving signals in the second driving method. During the reset period, a reset pulse is applied to all second sustaining electrodes Y(1)-Y(n) simultaneously for removing the unwanted wall charges in all discharge regions. During the address period, sequentially inputting a negative pulse to the second sustaining electrodes Y(1)-Y(n), and then selectively inputting a positive pulse to the address electrodes A(1)-A(m) according to the image data of each sub-frame. In the R-sustain period, the discharge regions C(R, p) are driven by providing two out-of-phase signals to the first sustaining electrode X(3k+1) and the second sustaining electrode Y(3k+1) respectively, and two out-of-phase signals to the second sustaining electrode Y(3k+2) and the first sustaining electrode X(3k+3). In the G-sustain period, the discharge regions C(G, p) are driven by providing two out-of-phase signals to the second sustaining electrode Y(3k+1) and the first sustaining electrode X(3k+2) respectively, and two out-of-phase signals to the first sustaining electrode X(3k+3) and the second sustaining electrode Y(3k+3) respectively. In the B-sustain period, the discharge regions C(B, p) are driven by providing two out-of-phase signals to the first sustaining electrode X(3k+2) and the second sustaining electrode Y(3k+2) respectively, and providing two out-of-phase signals to the second sustaining electrode Y(3k+3) and the first sustaining electrode X(3k′+1) respectively.

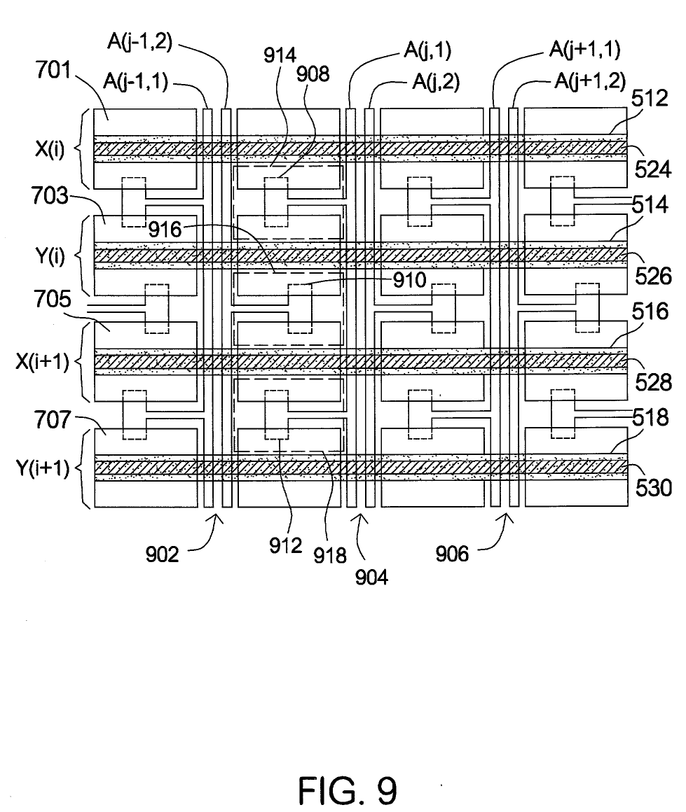

In the R-sustain period, the voltage difference between the first sustaining electrode X(3k+2) and the second sustaining electrode Y(3k+1) or Y(3k+2) should be lower than the lowest voltage value for triggering discharging between the first and second sustaining electrodes X and Y in order not to discharge the G sub-frame or the B sub-frame. That is, the first sustaining electrode X(3k+2) has a low voltage or the same voltage equal to the second sustaining electrode Y, According to the similar design approach, the first sustaining electrode X(3k+1) during the G sustain periods for G sub-frames, and the first sustaining electrode X(3k+3) during B sustain periods for B sub-frames will maintain at a low voltage or the same voltage as the second sustaining electrodes Y Referring to FIG. 9, it illustrates the third embodiment of the plasma display panel in a top view. In FIG. 9, the address electrodes on the rear plate are opposite to the gaps of the transparent electrodes on the front plate so that each discharge region can be addressed independently. Thus, the driving method used in the third embodiment can be simplified.

As shown in FIG. 9, the first address electrodes A(j−1, 1), A(j,1), and A(j+1, 1), and the second address electrodes A(j−1, 2), A(j, 2), and A(j+1, 2) are disposed opposite to the gaps 902, 904, and 906 respectively. A plurality of protruding electrodes are formed in the discharge regions and connected to the corresponding address electrodes. The second sustaining electrode Y(i) is disposed between two first sustaining electrodes X(i) and X(i+1). The first electrode address electrodes A(j−1, 1), A(j, 1), and A(j+1, 1) have protruding electrodes formed between the first sustaining electrode X(i) and the second sustaining electrode Y(i), and also have protruding electrodes formed between the first sustaining electrode X(i+1) and the second sustaining electrode Y(i+1). In addition, the second address electrodes A(j−1, 2), A(j, 2), and A(j+1, 2) have protruding electrodes formed between the second sustaining electrode Y(i) and the first sustaining electrode X(i+1).

For instance, the protruding electrode 908 is connected to the first address electrode A(j, 1) disposed on the rear plate. The protruding electrode 908 is in the sub-pixel 914, and overlaps the first and second sustaining electrodes X(i) and Y(i) in the top view. Similarly, the protruding electrode 910 is in the sub-pixel 916 and connected to the second address electrode A(j−1, 2), and the protruding electrode 912 is in the sub-pixel 918 and connected to the first address electrode A(j, 1). In FIG. 9, the protruding electrodes are T-shaped, but it is not to limit the shape of the protruding electrodes in practice.

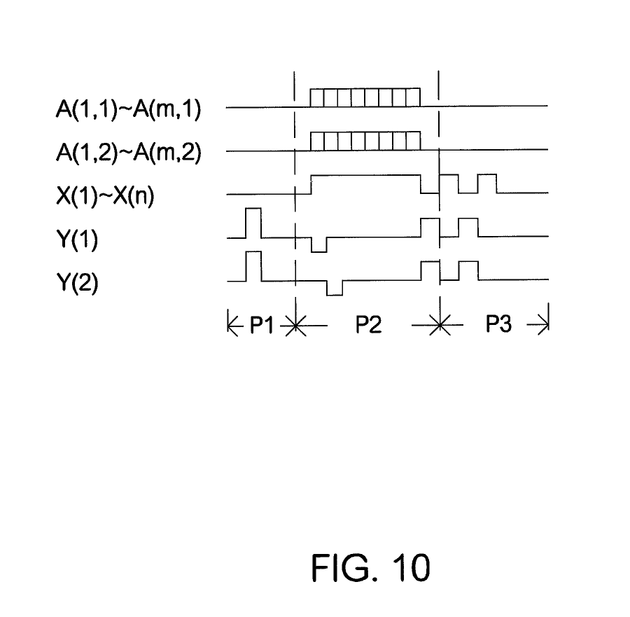

FIG. 10 is the waveform diagram illustrating the driving signals for the third embodiment of the plasma display panel. In the third embodiment, there are m sets of the address electrode; each set includes a first address electrode A(m, 1) and a second address electrode A(m, 2). There are also n sets of the first sustaining electrodes X and the second sustaining electrodes Y. During the address period P2, a high level voltage is applied to the first sustaining electrodes X(1) to X(n). When the second sustaining electrode Y(1) is selected, a negative pulse is applied to the Y(1), and a first image data can be written and displayed by the discharge regions between the Y(1) and X(1) using the first address electrodes A(1, 1)-A(m, 1). Further, a second image data can be written and displayed by the discharge regions between the Y(1) and X(2) using the second address electrodes A(1, 2)-A(m, 2). In this way, after scanning all second sustaining electrodes Y(1)-Y(n) in sequence, the image data can be written into the plasma display panel.

In the third embodiment, the discharge regions between the first sustaining electrode X(1) and the second sustaining electrode Y(1) are controlled by the first address electrodes A(1, 1)-A(m, 1), and the discharge regions between the second sustaining electrode Y(1) and the first sustaining electrode X(2) are controlled by the second address electrodes A(1, 2)-A(m, 2). That is to say, the discharge regions at different sides of a second sustaining electrode Y are controlled by two different sets of address electrodes. Thus, one address electrode is used to discharge only one discharge region when all first sustaining electrodes X(1)-X(m) are in the high level voltage during the address period P2. In this way, compared to the driving waveforms in FIGS. 8B and 8C, the driving waveforms of the third embodiment can be simplified, and the limitation is eliminated that the odd-numbered first sustaining electrode X(odd) and the even-numbered first sustaining electrode X(even) cannot be in the high level voltage at the same time.

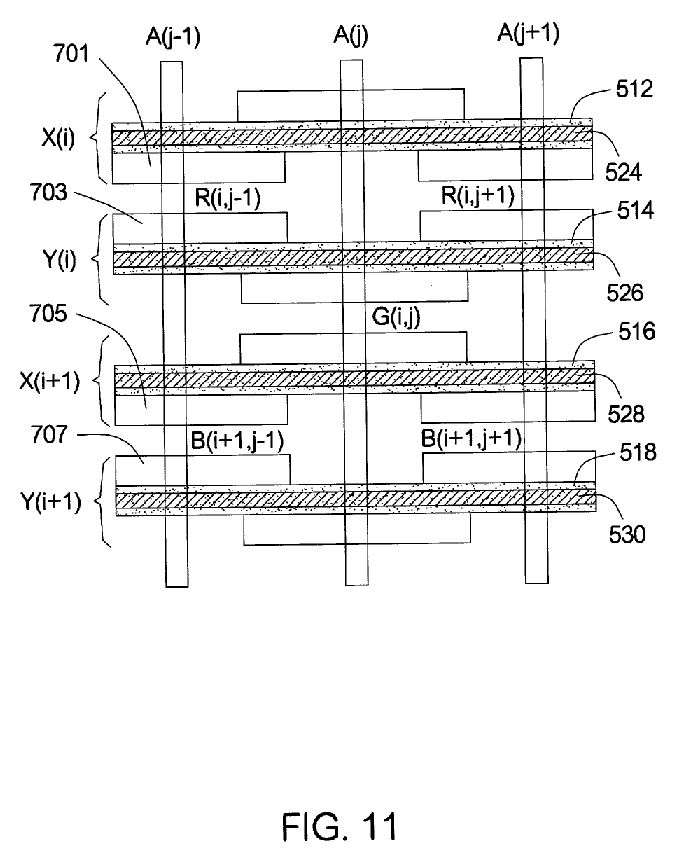

Referring to FIG. 11, it illustrates the fourth embodiment of the plasma display panel in a top view. The plasma display panel in FIG. 11 is obtained by changing some parts of the plasma display panel shown in FIG. 7. In FIG. 11, each bus electrode has the shape of a strip and each transparent electrode is disposed along the discharge regions in an S-shaped manner so that each sub-pixel can be addressed independently. In this way, another simplified driving method and driving circuit can be obtained by the fourth embodiment.

As shown in FIG. 11, discharging in the sub-pixel R(i, j−1) is controlled by the address electrode A(j−1), the first sustaining electrode X(i), and the second sustaining electrode Y(i). Discharging in sub-pixel R(i, j+1) is controlled by the address electrode A(j+1), the first sustaining electrode X(i), and the second sustaining electrode Y(i). Discharging in sub-pixel G(i, j) is controlled by the address electrode A(j), the first sustaining electrode X(i+1), and the second sustaining electrode Y(i). Discharging in sub-pixel B(i+1, j−1) is controlled by the address electrode A(j−1), the first sustaining electrode X(i+1), and the second sustaining electrode Y(i+1).

In this embodiment, around the intersection of each second sustaining electrode Y and each address electrode A, the transparent electrode of the second sustaining electrode Y are spaced apart from the transparent electrodes of the two adjacent first sustaining electrodes X by different distances. For example, a first discharge region is defined by the first sustaining electrode X(i), the second sustaining electrode Y(i), and the address electrode A(j−1). In the first discharge region, around the intersection of the second sustaining electrode Y(i) and address electrode A(j−1), the transparent electrode 703 of the second sustaining electrode Y(i) is separated from the transparent electrode 701 of the first sustaining electrode X(i) by a first distance, and is separated from the transparent electrode 705 of the first sustaining electrode X(i+1) by a second distance. The second distance is larger than the first distance. Therefore, the distance between the first sustaining electrode X(i+1) and the second sustaining electrode Y(i) is too long for discharging to occur by using the address electrode A(j−1). In the other words, no G sub-pixel is defined by the first sustaining electrode X(i+1), the second sustaining electrode Y(i), and the address electrode A(j−1).

The conventional driving method can be used in the fourth embodiment of the plasma display panel for scanning all second sustaining electrodes Y(1)-Y(n) sequentially to input all image data. For instance, when the second sustaining electrode Y(i) is scanned, the data are written into sub-pixels R(i, j−1), G(i, j), and R(i,j+1) . . . , etc. In the fourth embodiment, there is no need to (a) divided each frame into odd- and even-numbered sub-frames as in the first embodiment, or (b) use pairs of address electrodes as in the third embodiment.

According to the invention, the plasma display panel has high open ratio for bring high brightness and a reduction of the crosstalk phenomenon. By increasing the number of the address electrodes, the driving method can be simplified and the cost of the plasma display panel can be reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A plasma display panel, comprising:
a front plate;
a rear plate parallel and opposite to the front plate;
a plurality of first sustaining electrodes X and a plurality of second sustaining electrodes Y alternately formed on the front plate along a first direction;
a plurality of address electrodes formed on the rear plate along a second direction, the second direction being perpendicular to the first direction;
a plurality of ribs formed on the rear plate along said first direction and orthogonal to the address electrodes, and a plurality of discharge regions respectively defined between every two adjacent ribs; and
a plurality of fluorescent layers formed on the discharge regions respectively.

2. A plasma display panel according to claim 1, wherein each of the first sustaining electrodes X includes a first transparent electrode and a first bus electrode disposed on the first transparent electrode, each of the second sustaining electrodes Y includes a second transparent electrode and a second bus electrode disposed on the second transparent electrode, and the ribs are disposed under the corresponding bus electrodes.

3. A plasma display panel according to claim 2, wherein the first sustaining electrodes X include at least first sustaining electrodes X(i) and X(i+1), the second sustaining electrodes Y include at least a second sustaining electrode Y(i) disposed between the first sustaining electrodes X(i) and X(i+1), the address electrodes include at least an address electrode A(j−1), the address electrode A(j−1) is perpendicular to the first sustaining electrodes X(i), X(i+1), and the second sustaining electrode Y(i); and around the intersection of the second sustaining electrode Y(i) and address electrode A(j−1), the second sustaining electrode Y(i) and the first sustaining electrode X(i) are separated by a first distance, the second sustaining electrode Y(i) and the first sustaining electrode X(i+1) are separated by a second distance, and the second distance is larger than the first distance.

4. A plasma display panel according to claim 2, wherein between every two adjacent address electrodes, the first transparent electrode includes a plurality of gaps for reducing the crosstalk phenomenon.

5. A plasma display panel according to claim 2, wherein between every two adjacent address electrodes, the first transparent electrode includes a plurality of indentions, and a width of the first transparent electrode is equal to a width of the first bus electrode for reducing the crosstalk phenomenon.

6. A plasma display panel according to claim 1, wherein the discharge regions include a first discharge area and a second discharge area, the address electrodes include at least a first address electrode A1 and a second address electrode A2, and the plasma display panel further comprises:
a first protruding electrode formed in the first discharge area and connected to the first address electrode A1; and
a second protruding electrode formed in the second discharge area and connected to the second address electrode A2;
wherein the first address electrode A1 and one of the second sustaining electrodes Y are used for discharging in the first discharge area, and the second address electrode A2 and another of the second sustaining electrodes Y are used for discharging in the second discharge area.

7. A plasma display panel according to claim 6, wherein each of the second sustaining electrodes Y has a transparent electrode Yt and a bus electrode Yb, the transparent electrode Yt has an indention at the intersection of the second sustaining electrode Y and the first and second address electrodes A1 and A2.

8. A plasma display panel according to claim 6, wherein each of the second sustaining electrodes Y has a transparent electrode Yt and a bus electrode Yb, the transparent electrode Yt has a gap at the intersection of the second sustaining electrode Y and the first and second address electrodes A1 and A2.

9. A plasma display panel according to claim 6, wherein the first protruding electrode has a T-shaped structure.

10. A method for driving a plasma display panel, the plasma display panel comprising:
a front plate and a rear plate faced the front plate;
n first sustaining electrodes X including X(1) to X(n), and n second sustaining electrodes Y including Y(1) to Y(n), the first sustaining electrodes X and second sustaining electrodes Y being formed in parallel on the front plate along a first direction and spaced equally apart from each other, wherein the n first sustaining electrodes X are divided into odd-numbered first sustaining electrodes X(odd) and even-numbered first sustaining electrodes X(even);
a first discharge region being defined by the odd-numbered first sustaining electrodes X(odd) and the second sustaining electrodes Y, and a second discharge region being defined by the even-numbered first sustaining electrodes X(even) and the second sustaining electrodes Y;
a plurality of address electrodes formed on the rear plate along a second direction, the second direction being perpendicular to the first direction;
a plurality of ribs formed on the rear plate along the first direction; and
a plurality of fluorescent layers formed between every two adjacent ribs;
the method comprising steps of:
(a) inputting a reset pulse to each of the second sustaining electrodes Y(1) to Y(n) simultaneously;
(b) sequentially inputting a negative pulse to the second sustaining electrodes Y(1) to Y(n) and then selectively inputting a positive pulse to the address electrodes according to an image data; maintaining the odd-numbered first sustaining electrodes X(odd) in a high level voltage when the first discharge region being selected, and maintaining the even-numbered first sustaining electrodes X(even) in the high level voltage when the second discharge region being selected;
(c) inputting a first signal to the second sustaining electrodes Y, inputting a second signal to the odd-numbered first sustaining electrodes X(odd), and inputting a third signal to the even-numbered first sustaining electrodes X(even), wherein when the first discharge region is selected for discharging, the first signal is out of phase with the second signal and is in phase with the third signal, and when the second discharge region is selected for discharging, the first signal is in phase with the second signal and is out of phase with the third signal.

11. A method according to claim 10, wherein each of the first sustaining electrodes X comprises a first transparent electrode and a first bus electrode, each of the second sustaining electrodes Y comprises a second transparent electrode and a second bus electrode, the first bus electrode and the second bus electrode are disposed along centerlines of the first transparent electrode and the second transparent electrode respectively, and the ribs are disposed under the corresponding bus electrodes.

12. A method according to claim 10, wherein the bus electrodes are made of Cr/Cu/Cr metal, and the transparent electrodes are made of indium tin oxide (ITO).

13. A method according to claim 10, wherein the plurality of transparent electrodes include a plurality of gaps for reducing the crosstalk phenomenon.

14. A method according to claim 10, wherein the fluorescent layers comprise red, green, and blue fluorescent layers.

15. A method for driving a plasma display panel, the plasma display panel comprising:
a front plate and a rear plate faced the front plate;
n first sustaining electrodes X including X(1) to X(n), and n second sustaining electrodes Y including Y(1) to Y(n) formed in parallel on the front plate along a first direction and spaced equally apart from each other, wherein the n first sustaining electrodes X are divided into three groups of first sustaining electrodes X(3k+1), X(3k+2), and X(3k+3), and the n second sustaining electrodes are divided into three groups of second sustaining electrodes Y(3k+1), Y(3k+2), and Y(3k+3);
a first discharge region being defined by the first sustaining electrode X(3k+1) and the second sustaining electrode Y(3k+1), a second discharge region being defined by the second sustaining electrode Y(3k+1) and the first sustaining electrode X(3k+2), and a third discharge region being defined by the first sustaining electrode X(3k+2) and the second sustaining electrode Y(3k+2);
a plurality of address electrodes formed on the rear plate along a second direction, wherein the second direction is perpendicular to the first direction;
a plurality of ribs formed on the rear plate along the first direction; and
a plurality of fluorescent layers formed between every two adjacent ribs;
the method comprising steps of:
(a) simultaneously inputting a reset pulse to each of the n second sustaining electrodes Y(1) to Y(n);
(b) sequentially inputting a negative pulse to the n second sustaining electrodes Y(1) to Y(n), and selectively inputting a positive pulse to the address electrodes according to an image data;
(c) providing two out-of-phase signals to the first sustaining electrode X(3k+1) and the second sustaining electrode Y(3k+1), and providing two out-of-phase signals to the second sustaining electrode Y(3k+2) and the first sustaining electrode X(3k+3) when the first discharge region being selected for discharging;
(d) simultaneously inputting a reset pulse to each of the n second sustaining electrodes Y(1) to Y(n);
(e) sequentially inputting a negative pulse to the n second sustaining electrodes Y(1) to Y(n) and selectively inputting a positive pulse to the address electrodes according to the image data;
(f) applying two out-of-phase signals to the first sustaining electrode X(3k+2) and the second sustaining electrode Y(3k+1), and applying two out-of-phase signals to the second sustaining electrode Y(3k+3) and the first sustaining electrode X(3k+3) when the second discharge region being selected for discharging;
(g) simultaneously inputting a reset pulse to each of the n second sustaining electrodes Y(1) to Y(n);
(h) sequentially inputting a negative pulse to the n second sustaining electrodes Y(1) to Y(n) and selectively inputting a positive pulse to the address electrodes according to the image data; and
(i) applying two out-of phase signals to the first sustaining electrode X(3k+2) and the second sustaining electrode Y(3k+2), and applying two out-of-phase signals to the second sustaining electrode Y(3k+3) and the first sustaining electrode X(3k′+1) respectively when the third discharge region being selected for discharging, wherein k is a non-negative integer, n is a positive integer, and 3k′+1 is equal to 3k+4 and is not greater than n.

16. A method according to claim 15, wherein each of the first sustaining electrodes X comprises a first transparent electrode and a first bus electrode, each of the second sustaining electrodes Y comprises a second transparent electrode and a second bus electrode, and the first bus electrode and the second bus electrode are disposed along centerlines of the first transparent electrode and second transparent electrode respectively.

17. A method according to claim 16, wherein the ribs are disposed under the corresponding bus electrodes.

18. A method according to claim 16, wherein the bus electrodes are made of Cr/Cu/Cr metal, and the transparent electrodes are made of indium tin oxide (ITO).

19. A method according to claim 16, wherein between every two adjacent address electrodes, the plurality of transparent electrodes include a plurality of gaps for reducing the crosstalk phenomenon.

20. A method according to claim 15, wherein the fluorescent layers comprise red, green, and blue fluorescent layers.
